(19) United States
(12) Patent Application Publication
(10) Pub. No.: US 2023/0103421 A1
(43) Pub. Date: Apr. 6, 2023

(54) SHAPED BODY WITH A HEATING ELEMENT MADE TO HEAT POLYURETHANE FOAM

(71) Applicant: VARIOWELL DEVELOPMENT GMBH, Münster (DE)

(72) Inventor: Tobias KIRCHHOFF, Münster (DE)

(21) Appl. No.: 17/994,553

(22) Filed: Nov. 28, 2022

Related U.S. Application Data
(63) Continuation-in-part of application No. PCT/EP2021/064485, filed on May 31, 2021.

(30) Foreign Application Priority Data
May 29, 2020 (LU) 101825

(51) Int. Cl. A47C 21/04; A47C 27/15; A47C 27/14

(52) U.S. Cl. CPC A47C 21/048; A47C 27/15; A47C 27/148

(57) ABSTRACT

A shaped body including at least one section of a polyurethane foam. The shaped body includes a temperature-regulating device arranged in thermal contact with the at least one section of the polyurethane foam and a control device for the temperature-regulating device adapted to adjust the firmness of the at least one section of the polyurethane foam by alteration of temperature of the at least one section of the polyurethane foam this device being in “S” shape. The shaped body is used as a bed or mattress for promoting sleep in one application.

### CROSS REFERENCES TO RELATED APPLICATIONS

This application claims benefit to and priority of LU Patent Application No. LU101825 “A shaped body with a heating element made to heat polyurethane foam”, filed on 29 May 2020. This application is a Continuation-in-Part application based on International patent application number WO PCT/EP2021/064485 filed on 31 May 2021 and published as WO 2021/240012 A1.

### FIELD OF THE INVENTION

The invention relates to a shaped body with a heating element made with polyurethane foam to effectively concentrate thermal energy in certain sections. The invention further relates to a bed or mattress using this element.

### BACKGROUND OF THE INVENTION

U.S. Pat. 8,499,389 describes conventional viscoelastic or thermoelastic foams in conjunction with a temperature changing device and a control unit to create products with variable degree of firmness in typical use cases. When the temperature-changing device is cooled down from 30° C. back to ambient temperature it can take up to an hour before the foams become firm. Warming of the foams and thus softening of the foams is faster, but also takes 10 to 15 minutes. This feature limits the marketability of the products significantly. The sensitivity of the foams to body temperature means that a foam layer, made of the viscoelastic or thermoelastic foams, must be placed deep inside a product, otherwise the body temperature would override the effect of the warming device. This limits the effect experienced by the user.

The drawings in U.S. Pat. 8,499,389 show construction examples of products made with the foams and illustrate layers of foams, which is the usual method to combine different types of foam. A construction using foam layers does not permit sufficient ambient air to reach the foams to enable the foams to cool down. U.S. Pat. 8,499,389 teaches nothing about the foams or the material directly adjacent to the foam layers changing firmness. These factors are required for a fast change in the degree of firmness of a product, which is expected by a user.

U.S. Pat. application US 2015/320226 A1 describes a body support, such as a mattress, with a top layer and a lower layer. The top layer and/or the lower layer are made of a viscoelastic foam with a glass-transition temperature approximately within the range form 10° C. and 30° C. A fluid system comprising a conduit is positioned between the top layer and the lower layer. The top layer and/or the lower layer are shaped to at least partially receive the conduit, such as by having channels shaped and dimensioned to receive the conduit. The conduit is shown in the U.S. ‘226 Patent application as being oriented horizontally. The body support has a layered structure that does not include air channels or chambers and that therefore does not provide air-cooling for the body support.

U.S. Pat. application US 2007/272673 A1 describes an electric blanket in which a heating element is arranged between scrim layers and a foam layer and is integrated in the scrim layers.

U.S. Pat. application US 2016/331150 A1 describes a foam mattress having a body facing surface comprising a viscoelastic foam layer. The body facing surface further comprises a recess or cavity into which a layer including a core of springs may be provided. The foam mattress further having a layer of open cell foam beneath the viscoelastic foam layer.

Japanese patent application JP 2010 119708 A describes an upper layer member comprising a polyolefin foam resin sheet, an intermediate layer material comprising a polyolefin resin bubble cushion sheet with a number of air-enclosed projections, which is called an air cap or the like, and a lower layer member comprising flexible polyurethane foam material are laminated in this order from the top.

European patent application EP 2 806 771 A describes foam mattress constructions and engineered foams which contain additives for improved mechanical and thermal properties. The engineered foam for use as a layer in a foam mattress construction has multiple layers including a top layer of foam and at least one additional layer of foam, and a coating of phase change material applied to a top surface of the top layer of foam. Surface application of phase change material to a top surface of a top layer of foam of a foam mattress provides more efficient transfer of heat away from a body on the mattress and reduced heat accumulation at the body-mattress interface.

International patent application WO 2020/131568 A1describes a bedding system which includes a viscoelastic foam layer with a glass transition temperature greater than 60° F. at 0% humidity, a signal generating layer, and a control unit. The signal generating layer is a separate layer in the bedding system and is used to generate heat to alter a firmness of the viscoelastic layer. The signal generating layer is located underneath the viscoelastic foam layer and is not integrated into the viscoelastic foam layer.

### SUMMARY OF THE INVENTION

A shaped body is described in this document. The shaped body comprises of two different materials one being conventional polyurethane foam the other being a heating element e producing thermal energy to reach temperatures between 25° C. to 95° C. The thermal energy producing element is inserted into the foam material in an ‘S’-shape or “Z”-shape. The heating element can be configured as a temperature generating layer shaped as an “S” or “Z”. This ‘S’-shape or “Z”-shape will concentrate the thermal energy produced within the inner section of the foam and any temperature rise by inserting thermal energy is fast. Also, when the foam should cool down the drop in thermal energy level is fast, because the distance from any foam section to the adjacent air is short.

Furthermore, the “S”-shape or “Z”-shape supports a smooth compression of the foam body, this compression triggered by either the force of the body or mechanical force to compress the shaped (foam) body to reduce volume for transport purposes.

A textile band is described, this band coated with Polyurethane blended with electric conductive particles.

### BRIEF DESCRIPTION OF THE DRAWINGS

FIG. 1 shows a construction of a firmness-adjustable section of a shaped body with a dynamic foam.

FIG. 2 shows an alternative construction of the shaped body.

FIG. 3 shows a modification of the shaped body of FIG. 1.

FIG. 4 shows a further modification of the dynamic foam.

### DETAILED DESCRIPTION OF THE INVENTION

The present document illustrates method to effectively insert thermal energy into an element made of foam by concentrating the thermal energy to small sections of an overall element. This has advantages when intending to heat foam so that a piece of furniture (like a seat) or a mattress should warm the user but only at defined sections and not overall.

Further the body as disclosed can be used with foam with modified foam parameters, called ‘dynamic foam’. These dynamic foams are foams with a glass transition temperature above 15° C. This body can be used in connection with a warming device and controller, as explained below. The dynamic foam of this disclosure can be used in combination with the construction known from U.S. Pat. US 8,499,389. The dynamic foam can be combined with other material, such as but not limited to springs, non-dynamic PU foam, which enhances the specific comfort properties of each material.

The use of a body as disclosed with the dynamic foams enables products, such as but not limited to mattresses for use in beds, that can change their firmness very quickly. The dynamic foams can be used in (but not limited to) the temperature range of between 18° C. and 28° C. The dynamic foams are able to rapidly change their firmness without being actively cooled. This contrasts with viscoelastic materials known from the art that can change their firmness but require active cooling. It is also known that viscoelastic materials change their firmness rapidly only in a temperature range between 0° C. and 15° C., which makes the viscoelastic materials unsuitable for use in mattresses on which a person is sleeping at typical room temperatures.

The body as described in this document in combination with a warming device and controller enable the use of such dynamic foams in areas which are close to the surface of a product, such as in the bed. The body enables significant changes in the firmness of the bed which are — unlike the foams known in the art --substantially independent of the influence of body temperature on their firmness. This means that the body of this disclosure can be placed closer to the surface of a mattress of the bed, and therefore the changes in firmness are more perceptible during the use of the bed.

The shaped body together with a temperature changing device enabling the warming of the foams in the range from 20° C. to 50° C. and the corresponding controller results in the product with the desired properties. The inventors have established that the changes in the firmness of the foam itself are rapid and can be clearly noticed by the user, even with small changes in the temperature caused by the temperature changing device.

The body of this disclosure forms only one part of the product and can be integrated into complete products. It has been found that overall height and/or thickness of the dynamic foam can be kept very thin. The thin design of the dynamic foam results in a rapid penetration of this thin dynamic foam piece with the desired amount of thermal energy (when the temperature rises) and a rapid release of the thermal energy throughout the thin piece of the dynamic foam, if a temperature drop is desired.

Conventional products containing different types of foam are usually designed such that these different types of foams are placed horizontally adjacent to each other. Such a construction is easy to manufacture as the foams can be glued to each other. It has been found, however, that a conventional construction like this is inferior to a fast firmness change of the product.

The upper part and the lower part of the dynamic foam are firmly fixed to the overall construction as this will enable the dynamic foam to return to the original shape after removal of a load. Research has shown that the foams with a modified glass transition phase do not return to the original shape by itself after compression as fast as conventional foam.

The construction can include channels or holes in the dynamic foam or elsewhere to allow warmer air to leave the section of the dynamic foam, based on the tendency of warmer air to rise.

The construction also includes complementary material of which most of the overall product is constructed. This complementary material has a high recovery force, meaning that the complementary material has enough force to return to its original shape after compression. This complementary material can be also a foam or alternatively or additionally the complementary material can be metal springs as used conventionally in innerspring products, like mattresses or seating. The combination of the dynamic foam as taught by this document and the complementary material allows the overall product to become soft after the temperature of the dynamic foam having a raised temperature. The product still has a degree of resiliency only due to the standard foam or the spring-based body. Once the thermal energy leaves the body, the product will return substantially to its previous shape as the complementary material will push the whole surrounding body, including the section made of the dynamic foam back to original shape.

The temperature-regulating device can be made from small bands, these bands being coated with Polyurethane, this Polyurethane being blended with electric conductive material. If connected to electric current, the electric conductive material will generate heat through its own electric resistance.

### EXAMPLES

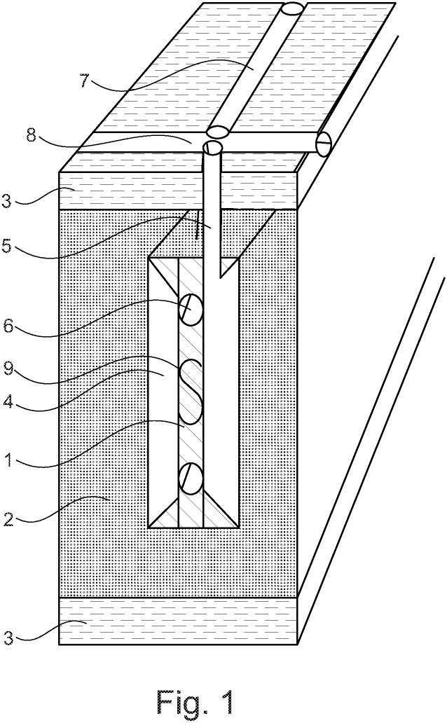

FIG. 1 shows a typical construction of a firmness adjustable section of a shaped body, such as the aforementioned bed or the mattress. Several of these sections can be placed adjacent to each other, either horizontally or vertically or both to form the complete product. The section can also be used alone within a complete product, adjusting firmness of this section only.

The dynamic foam 1 shown in FIG. 1 is a thin vertically erected rectangular slice from one side of the section to the opposite side. The dynamic foam 1 widens at an upper section and a lower section. The dynamic foam 1 is glued to the adjacent surfaces of a surrounding material 2 at the upper section and lower section. In the illustrative example shown in FIG. 1, a high recovery foam made, for example, from polyurethane, is used as the complementary material 2. A standard foam material 3 is glued to the top and bottom of the combination of the dynamic foam 1 and the complementary material 2. The dynamic foam 1 and the complementary material 2 form an empty open space 4 filled with ambient air.

There may be further holes or channels 5 to 8 in the shaped body to enhance air movement within the shaped body. Horizontal channels 6 within the dynamic foam 1 are enhancing faster cooling of the dynamic foam 1, as the air can leave faster outside of the dynamic foam part. Vertical channels 5, which are cut into the modified foam 1 and the complementary material 2 just above the air chamber 4, will prevent warm air from collecting in the upper portion of the air chamber 4, as the warm air tends to stream upwards. It is therefore sucked away from the dynamic foam 1 and cannot influence the firmness of the dynamic foam 1 anymore. The horizontal channels 7 and 8 enable this warmer air to be streamed away from the dynamic foam 1. It should be noted that the construction can include none, some or all of the described holes/channels. The heating element can be configured as a temperature generating layer 9 is firmly fixed or glued inside the dynamic foam 1 in “S” shape. The temperature generating layer 9 is connected by cable to an outside controller. The temperature generating layer 9 can also be firmly fixed or glued inside the dynamic foam 1 in “Z” shape (not shown).

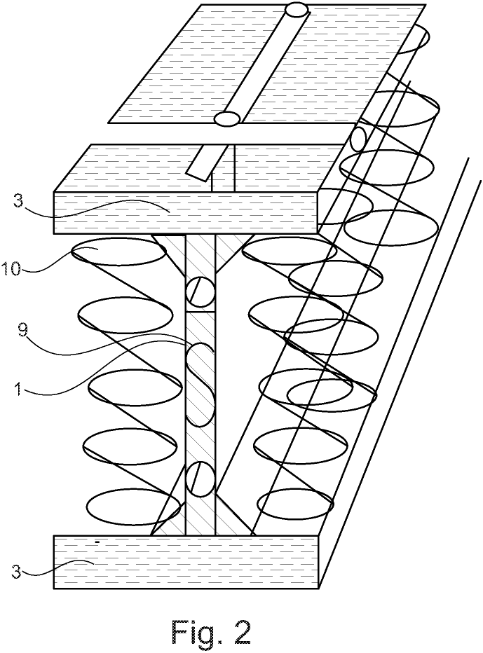

FIG. 2 shows an alternative construction of the shaped body in which the complementary material (equivalent to element 2 in FIG. 1) is composed of a plurality of pocketed metal springs 10. These pocketed metal springs 10 are used widely in the furniture industry. The pocketed metal springs 10 are normally used adjacent to each other to form a layer of springs for providing comfort. The pocketed metal springs 10 have a load-deflection curve different from that of the dynamic foam 1. A combination of inner springs 10 with the dynamic foam 1 can be constructed that will lead to a smooth and — with thermal energy — adjustable load deflection curve. The exact position of each of the materials, i.e. the dynamic foam 1 and the pocketed metal springs 10, can be very different. The dynamic foam 1 is fixed to an upper section and a lower section of the foam 3, so that the dynamic foam 1 can recover its original shape after a load is removed. The heating element can be configured as a temperature generating layer 9 is firmly fixed or glued inside the dynamic foam 1 in “S” shape. The temperature generating layer 9 is connected by cable to an outside controller. The temperature generating layer 9 can also be firmly fixed or glued inside the dynamic foam 1 in “Z” shape (not shown).

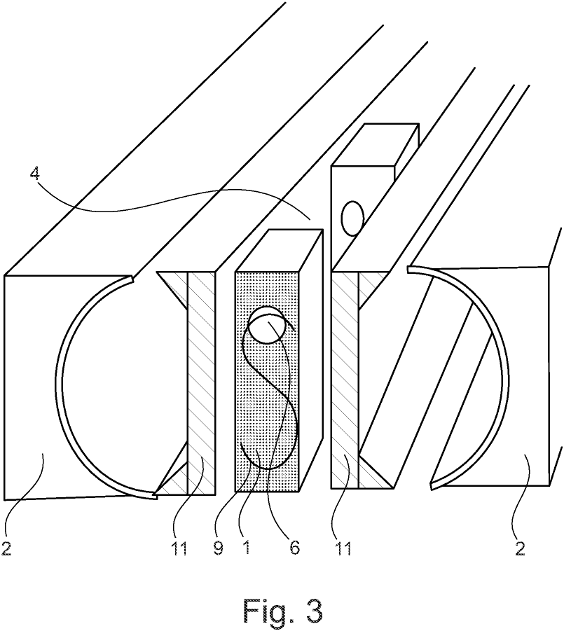

FIG. 3 is a modification of FIG. 1 with a broader base of the dynamic foam 1. The dynamic foam 1 in FIG. 3 comprises two vertical layers attached to each other with blocks of dynamic foam 1. The blocks 11 can create an empty space 4 and may have none, one or several holes and channels 6 to release thermal energy to the outside. The vertical layers of the dynamic foam 1 are attached to the complementary material 2 at the upper section and the lower section with a distance between both materials in the middle creating another horizontal empty space with air. The temperature generating layer 9 is within the blocks of dynamic foam 1 in “S” shape. The temperature generating layer 9 can also be within the blocks of dynamic foam 1 in “Z” shape (not shown).

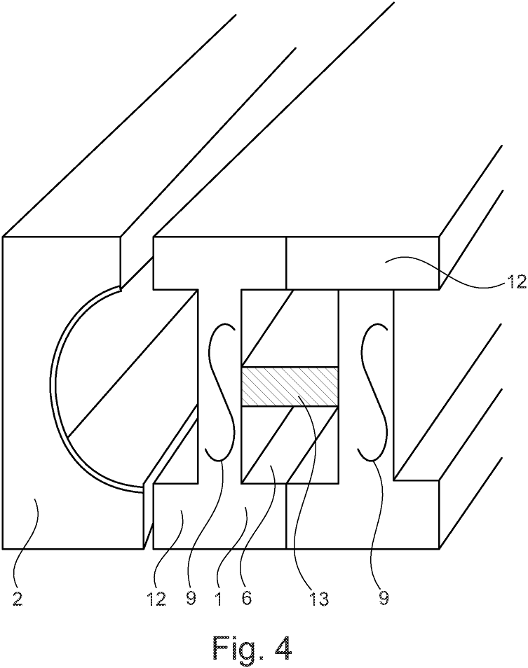

FIG. 4 is a different version to construct a section with the dynamic foam 1. Two of the vertical layers of the dynamic foam 1 with an extension 12 to both sides on the upper section and the lower section are attached to each other on one side at the extensions 12 and to the complementary material 2 on the outside. The middle section of each of the vertical layers of the dynamic foam 1 is attached to each other by a different layer 13 of material, this material can be the same material as the dynamic foam 1, as the complementary material 2 or be any other different flexible material. This construction creates two horizontal empty spaces 6 which can collect and distribute excessive thermal energy to the outside of the body. As this construction has a complete layer of the dynamic foam 1 on the top, and as this dynamic foam 1 has high insulation properties, the excessive thermal energy is not released towards the user at the top. The temperature generating layer 9 is placed within each vertical layer of the dynamic foam 1 in “S” shape. The temperature generating layer 9 can also be placed within each vertical layer of the dynamic foam 1 in “Z” shape (not shown).

### REFERENCE NUMERALS

1 Dynamic foam
2 Complementary materials, like standard comfort foam
3 Other materials, like standard comfort foam
4 Air chambers created by empty space between foam
5 Vertically empty space within the dynamic foam
6 Horizontally empty space within dynamic foam
7 Horizontally empty space leading from the air chamber
8 Horizontally empty space above dynamic foam connected to vertically empty space within modified foam.
9 Temperature generating layer in the dynamic foam section
10 pocketed metal springs
11 Conventional foam block
12 horizontal extensions to vertical layers of dynamic foam 1
13 Layer of material between vertical layers of dynamic foam 1

What is claimed is:

1. A shaped body, comprising:
at least one section of a polyurethane foam having an integrated heating element producing thermal energy, wherein the heating element is inserted into the foam in the shape of a vertically arranged ‘S’ or ‘Z’.

2. The shaped body according to claim 1, further comprising:
at least one section of a polyurethane foam having a glass transition temperature between 15° C. to 75° C.;
a temperature-regulating device arranged in thermal contact with the at least one section of the polyurethane foam; and
a control device for the temperature-regulating device adapted to adjust the firmness of the at least one section of the polyurethane foam by alteration of temperature of the at least one section of the polyurethane foam.

3. The shaped body according to claim 1, further comprising a plurality of sections of the polyurethane foam.

4. The shaped body according to claim 1, wherein the at least one section of the polyurethane foam is arranged in a vertical layer with a thickness between 0.5 cm to 7.0 cm preferably between 2.5 cm to 3.5 cm.

5. The shaped body according to claim 4, wherein the vertical layer has an upper section and a lower section, and the vertical layer is fixed to a complementary material at the upper section and lower section.

6. The shaped body according to claim 4, wherein the vertical layers have at least one of a horizontal channel or a vertical channel.

7. The shaped body according to claim 1, further comprising aluminum foil on top of or inside the shaped body.

8. The shaped body according to claim 2, wherein the temperature regulating device is a warming device.

9. Use of the shaped body according to claim 1 as a bed or a mattress.

10. The shaped body according to claim 2, where the controller uses sensor data of actual relative or absolute humidity to adjust the temperature of the temperature-regulating device according to the desired firmness levels taking into account relative or absolute humidity.

11. A shaped body with a heating element producing thermal energy being a textile band coated with Polyurethane this Polyurethane blended with electric conductive particles.

12. The shaped body according to claim 2, further comprising a plurality of sections of the polyurethane foam.

13. The shaped body according to claim 12, wherein the at least one section of the polyurethane foam is arranged in a vertical layer with a thickness between 0.5 cm to 7.0 cm preferably between 2.5 cm to 3.5 cm.

14. The shaped body according to claim 13, wherein the vertical layer has an upper section and a lower section, and the vertical layer is fixed to a complementary material at the upper section and lower section.

15. The shaped body according to claim 14, wherein the vertical layers have at least one of a horizontal channel or a vertical channel.

16. The shaped body according to claim 15, further comprising aluminum foil on top of or inside the shaped body.

17. The shaped body according to claim 16, wherein the temperature regulating device is a warming device.

18. The shaped body according to claim 17, where the controller uses sensor data of actual relative or absolute humidity to adjust the temperature of the temperature-regulating device according to the desired firmness levels taking into account relative or absolute humidity.
